(19) United States
(12) Patent Application Publication
(10) Pub. No.: US 2026/0356480 A1
(43) Pub. Date: Nov. 12, 2026

(54) OVERHEAD LUGGAGE COMPARTMENT

(71) Applicant: FACC AG, Ried im Innkreis (AT)

(72) Inventor: Bernhard KAMMERER, Zell an der Pram (AT)

(21) Appl. No.: 19/130,037

(22) PCT Filed: Nov. 24, 2023
(86) PCT No.: PCT/AT2023/060411

§ 371 Date: May 14, 2025

(30) Foreign Application Priority Data
Nov. 25, 2022 (AT) A 50897/2022

(51) Int. Cl. B64D 11/00; E05D 3/02; E05D 5/04

(52) U.S. Cl. CPC B64D 11/003; E05D 3/02; E05D 5/046; B64D 2011/0038; B64D 2203/00

(57) ABSTRACT

Overhead luggage compartment for an aircraft, comprising:—a luggage compartment housing with two side parts, an upper part, and a lower part, which enclose a receiving space for pieces of luggage,—a door,—a hinge device connected to the upper part and the door respectively, the door by means of the hinge device being pivotable relative to the luggage compartment housing between an open position and a closed position, the hinge device comprising a mounting clamp with an upper mounting leg and a lower mounting leg, the upper mounting leg being attached to the upper side of the upper part and the lower mounting leg being attached to the lower side of the upper part.

### CROSS REFERENCE TO RELATED APPLICATIONS

The present application is a U.S. National Phase of International Application No. PCT/AT2023/060411 entitled “OVERHEAD LUGGAGE COMPARTMENT,” and filed on Nov. 24, 2023. International Application No. PCT/AT2023/060411 claims priority to Austrian Patent Application No. A 50897/2022 filed on Nov. 24, 2022. The entire contents of each of the above-listed applications are hereby incorporated by reference for all purposes.

### TECHNICAL FIELD

The invention relates to an overhead luggage compartment for an aircraft, comprising:
a luggage compartment housing with two side parts, an upper part, and a lower part, which enclose a receiving space for pieces of luggage,
a door,
a hinge device, connected to the upper part and to the door, respectively, wherein the door by means of the hinge device is pivotable relative to the luggage compartment housing between an open position and a closed position.

### BACKGROUND AND SUMMARY

In the prior art, overhead luggage compartments are known in which passengers can stow their carry-on luggage during a flight. In one embodiment of overhead luggage compartments, which is also referred to as a “shelf bin,” a fixed luggage compartment housing is provided, which is closed by a door. Hinges are mounted on the luggage compartment housing and on the door, allowing the door to be pivoted upward from the closed position into an open position. Such a luggage compartment is described, for example, in U.S. Pat. No. 10,077,111 B2. In this prior art, the hinges are attached to the inside of the luggage compartment housing and to the door. However, a disadvantage is that the hinges protrude far into the receiving space for the pieces of luggage. Moreover, the pivot axis of the hinges lies well below the plane of the upper part of the luggage compartment housing. Finally, mounting the hinges in the prior art places a heavy load on the luggage compartment housing.

The general prior art is further illustrated by DE 10 2019 004754 A1 and WO 2012/003964 A1.

By contrast, the object of the present invention is to mitigate or eliminate at least individual disadvantages of the prior art. The invention preferably aims to create an overhead luggage compartment of the “shelf bin” type in which the suspension of the door on the luggage compartment housing restricts the receiving space available for luggage to a lesser extent, reduces the load on the upper part of the luggage compartment housing, and ultimately enables a favorable pivoting movement of the door.

This object is achieved by an overhead luggage compartment having the features described herein.

According to the invention, the hinge device comprises a mounting clamp with an upper mounting leg and a lower mounting leg, the upper mounting leg being attached to the upper side of the upper part and the lower mounting leg being attached to the lower side of the upper part.

For the purposes of this disclosure, position and directional indications such as “top,” “bottom,” “horizontal,” “vertical” refer to the intended mounted state of the overhead luggage compartment in the aircraft fuselage with the aircraft oriented horizontally.

Thus, the hinge device is mounted on the upper part of the luggage compartment housing via the mounting clamp. The mounting clamp comprises the upper and lower mounting legs, which are arranged essentially parallel and at a distance from one another, with the upper part of the luggage compartment housing located between the upper and lower mounting legs of the mounting clamp. The upper part is preferably configured as a top panel. The mounting clamp can grip around a front longitudinal edge—i.e., an edge facing the user of the overhead luggage compartment—of the upper part. The embodiment of the hinge device according to the invention offers a number of advantages. By gripping around the upper part of the luggage compartment housing, a stable suspension of the door is provided. As a result, the lower and upper mounting legs can be designed to be flat, so that the receiving space in the luggage compartment housing, bounded upwardly by the upper part, is barely restricted. Moreover, the torques occurring during the pivoting of the door can be absorbed in a particularly favorable manner with the mounting clamp. The upper part of the luggage compartment housing can be effectively protected from weakening and damage.

In order to restrict the receiving space for the pieces of luggage as little as possible, it is advantageous if the pivot axis of the hinge device extends in a plane between the upper and lower sides of the upper part of the luggage compartment housing. Thus, the pivot axis is located between the imaginary extensions of the upper and lower sides of the upper part of the luggage compartment housing. As a result, the hinge device is arranged in the height direction so as to overlap with the upper part of the luggage compartment housing. Because the pivot axis is not, as in the prior art, below the upper part but rather at the height of the upper part, the receiving space available for the pieces of luggage can be enlarged. It is particularly advantageous that this also makes it easier to load the piece of luggage.

In a preferred embodiment, the pivot axis of the hinge device extends in a plane essentially centered between the upper and lower sides of the upper part of the luggage compartment housing. In this embodiment, the pivot axis is arranged at the height of the mid-plane of the upper part, so that on the one hand the receiving space inside the luggage compartment housing is kept clear, and on the other hand a favorable force transmission is achieved when the door is pivoted.

For mounting the hinge device on the luggage compartment housing, it is advantageous if the upper and lower mounting legs of the hinge device can be pivoted relative to each other. During assembly, the upper and lower mounting legs can be placed in an unfolded state over the upper part and then brought into a folded state in order to position the upper mounting leg on the upper side and the lower mounting leg on the lower side of the upper part. In the mounted, folded state, the upper and lower mounting legs preferably extend essentially parallel at a distance from each other that essentially corresponds to the wall thickness of the upper part of the luggage compartment housing.

To securely hold the mounting clamp on the upper part of the luggage compartment housing, in a preferred embodiment of the invention, the upper and lower mounting legs of the hinge device are connected to each other by a screw connection.

In a preferred embodiment, the screw connection between the upper and lower mounting legs of the hinge device passes through a recess in the upper part of the luggage compartment housing. Through this recess, the mounting position of the mounting clamp can be varied in at least one direction, preferably in the horizontal direction perpendicular to the longitudinal edge of the upper part, i.e., forwards or backwards.

In order to arrange the door so that it can pivot on the otherwise stationary luggage compartment housing, the hinge device in a preferred embodiment comprises a pivot arm, which is attached to the inside of the door. The pivot arm is mounted so as to pivot about the pivot axis, so that the door attached to the pivot arm can be pivoted from the closed position, in which it closes the loading opening of the luggage compartment housing, into the open position, in which it exposes the loading opening of the luggage compartment housing.

For forming the pivot axis for pivoting the door relative to the luggage compartment housing, it is advantageous if the hinge device comprises at least one first hinge part, in particular a first round part, connected to the mounting clamp, and at least one second hinge part, in particular a second round part, connected to the pivot arm. The second hinge part is preferably mounted so that it is pivotable relative to the first hinge part.

A lighting device can be arranged on the upper side of the upper part of the luggage compartment housing, which in particular comprises a number of LED lighting elements. Advantageously, the hinge device hardly restricts the installation space for the lighting device. The lighting device is preferably designed as an elongated flat housing in the longitudinal direction of the aircraft fuselage. Moreover, the lighting device can comprise an integrated ventilation unit for supplying air to the aircraft cabin.

In order to ensure illumination of an aisle area even in the open position of the door, in a preferred embodiment, in the open position of the door, a longitudinal gap is formed between the upper side of the upper part of the luggage compartment housing and the upper longitudinal side of the door relative to the doors closed position. When the door is open, light from the lighting device located on the upper part can pass through the first longitudinal gap into the aisle area of the aircraft. To form the longitudinal gap, the hinge device preferably comprises an elongated pivot arm with which the door is pivoted into the open position.

To assist the pivoting of the door from the closed to the open position, the hinge device in a preferred embodiment comprises a spring element, in particular a torsion spring.

To improve the opening kinematics, the hinge device in a preferred embodiment comprises a damper element, in particular a torsion damper, for damping the pivoting of the door from the closed to the open position.

In a preferred embodiment, the overhead luggage compartment is connected to the aircraft fuselage via connecting elements, which are preferably designed as tie rods. It is particularly preferred if a rear connecting element and a front connecting element (i.e., arranged closer to the door) are provided on each transverse side of the overhead luggage compartment. Preferably, at least one of the connecting elements, preferably the two front connecting elements, is adjustable in length so that a tolerance compensation can be made.

The invention is further explained below with reference to an exemplary embodiment shown in the drawings.

### BRIEF DESCRIPTION OF THE FIGURES

FIG. 1 shows a side view of an overhead luggage compartment according to the invention for installation in an aircraft cabin.

FIG. 2 shows a 3D view of the overhead luggage compartment of FIG. 1.

FIG. 3 shows a sectional view of the overhead luggage compartment of FIG. 1 and FIG. 2 in the area of a hinge device according to the invention, with which a door of the overhead luggage compartment of FIG. 1 and FIG. 2 can be pivoted between a closed position and an open position.

FIG. 4 shows a sectional view of the hinge device according to FIG. 1 to 3 in the mounted state on an upper part (top panel) of a luggage compartment housing.

FIG. 5 shows a diagrammatic view of the hinge device according to one of FIG. 1 to 4.

### DETAILED DESCRIPTION

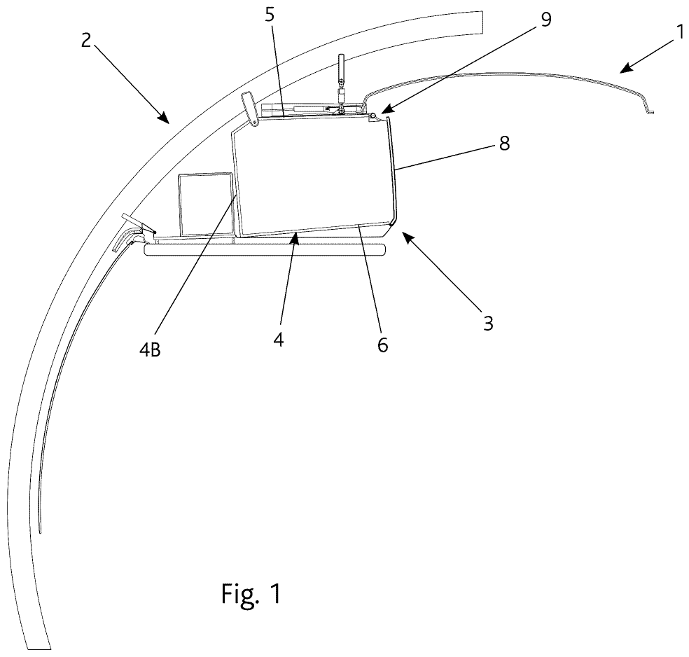

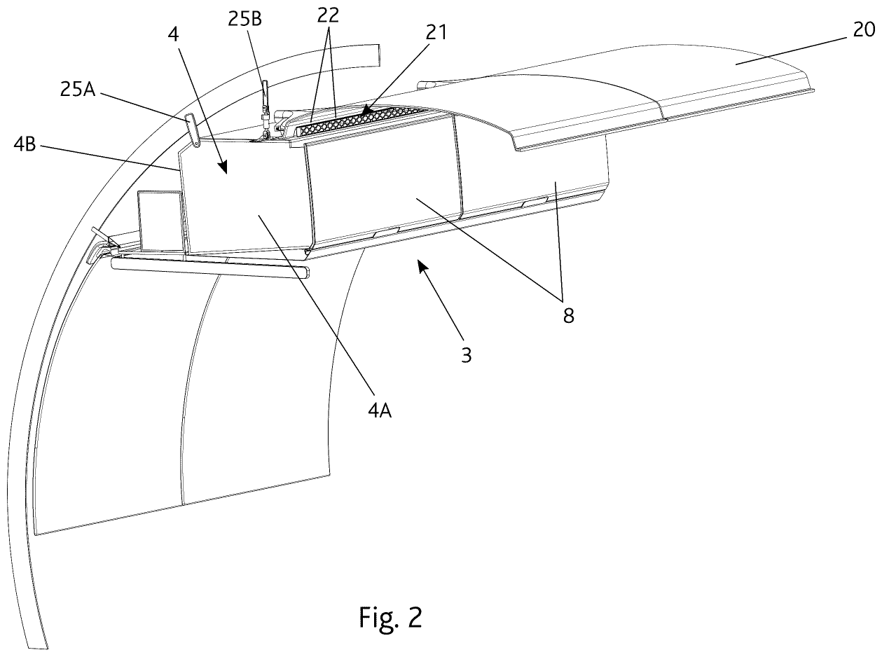

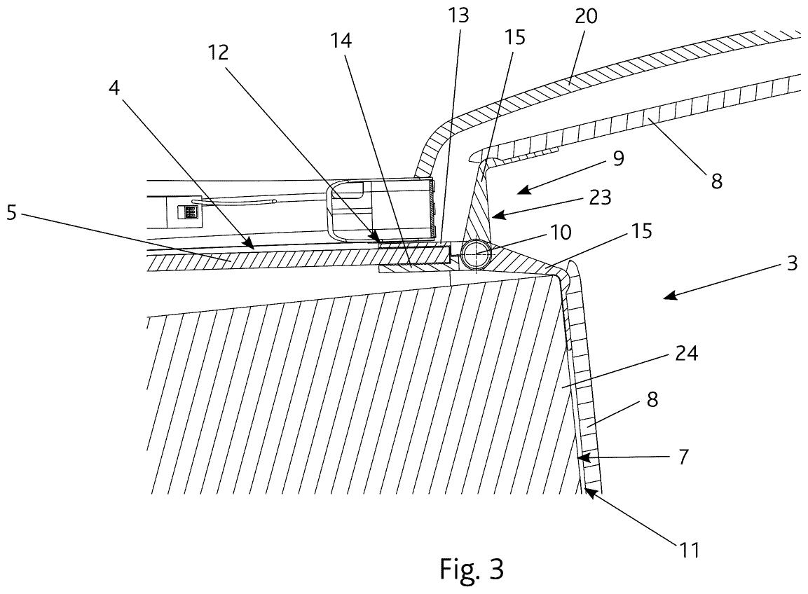

FIG. 1 and FIG. 2 show a section of an aircraft cabin 1 inside an aircraft fuselage of an aircraft 2. At least one overhead luggage compartment 3 is mounted in the aircraft cabin 1. Depending on the embodiment, several overhead luggage compartments can be arranged along the aircraft cabin, in particular next to an aisle. The overhead luggage compartment 3 comprises a luggage compartment housing 4 with two side parts 4A, which are connected on the top side by an upper part 5, on the bottom side by a lower part 6, and on the rear side by a rear wall 4B, so that a receiving space 7 for a piece of luggage 24 is bounded (cf. FIG. 3). At least one door 8 is provided on the front side of the overhead luggage compartment 3, facing the user, which is in each case connected to the luggage compartment housing 4 via at least one hinge device 9. Two doors 8 are provided in the embodiment shown.

As can be seen from FIG. 3 to FIG. 5, the hinge device 9 forms a pivot axis 10 running in the longitudinal direction of the overhead luggage compartment 3, i.e., in the direction of the aircrafts longitudinal axis, about which the door 8 can be pivoted between an open position that exposes a front loading opening 11 and a closed position that closes the front loading opening 11. In FIG. 3, the two doors 8 can be seen, one door 8 being shown in the closed position and the other door 8 in the open position.

As can be seen from FIG. 3 to FIG. 5, the hinge device 9 comprises a mounting clamp 12 with an upper mounting leg 13 and a lower mounting leg 14. The upper mounting leg 13 rests on the upper side of the upper part 5, and the lower mounting leg 14 rests on the lower side of the upper part 5. The upper mounting leg 13 and the lower mounting leg 14 can have ribbed inner surfaces to improve their grip on the upper part 5. In addition, the hinge device 9 comprises a pivot arm 15, which is pivotably mounted at one end around the pivot axis 10 and is attached at the other end to the inside of the door 8.

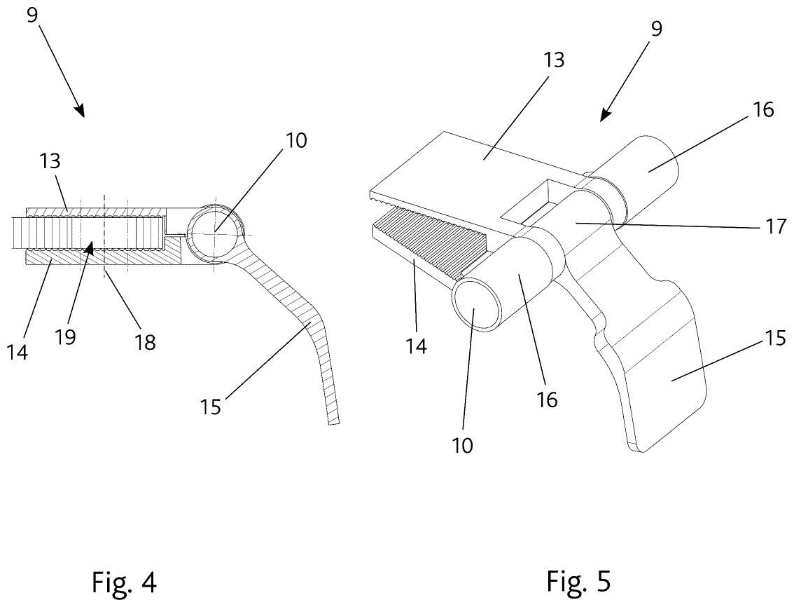

As can be seen from FIG. 4 and FIG. 5, to form the pivot axis 10, the hinge device 9 comprises two stationary first hinge parts 16, spaced apart from each other in the longitudinal direction of the luggage compartment housing 4, in this case first round parts, which in the embodiment shown are integrally connected to the lower mounting leg 14. A second hinge part 17, here a second round part, is connected to the pivot arm 15 and is mounted so that it can rotate relative to the first hinge parts 16. In the embodiment shown, the second hinge part 17 is integrally connected to the pivot arm 15. The upper mounting leg 13 is mounted pivotably relative to the lower mounting leg 14.

As can be seen from FIG. 4, the pivot axis 10 of the hinge device 9 is located in a horizontal plane centered between the upper and lower sides of the upper part 5 of the luggage compartment housing 4.

As shown in FIG. 4, the upper mounting leg 13 and the lower mounting leg 14 of the hinge device 9 can pivot relative to each other (see double arrow 9A in FIG. 4). When the door 8 is opened or closed, the pivot arm 15 pivots in the direction of arrow 9B. During assembly, the mounting clamp 12 is slipped onto the upper part 5 in the unfolded state and then folded into the desired position. In the embodiment shown, the upper mounting leg 13 and the lower mounting leg 14 of the hinge device 9 are connected to each other via a screw connection 18, indicated by a dashed line in the figure. The screw connection can comprise one or more screws. In the embodiment shown, the screw connection 18 passes through a recess 19 of the upper part 5 of the luggage compartment housing 4. The recess 19 extends in the horizontal direction perpendicular to the longitudinal edge of the upper part 5, so that the mounting position of the mounting clamp 12 can be varied.

As best seen in FIG. 2, a lighting and ventilation device 21 is mounted on the upper side of the upper part 5 of the luggage compartment housing 4, below a ceiling panel 20, with which light and air can be supplied to the aircraft cabin. The lighting and ventilation device comprises individual lighting elements 22, in particular LEDs, provided on a grid-like carrier that extends along a front air outlet of the lighting and ventilation device 21. Owing to the pivot arm 15, in the open position of the door 8, a longitudinal gap 23 is formed between the upper side of the upper part 5 of the luggage compartment housing 4 and the doors upper longitudinal side relative to its closed position.

The hinge device 9 can comprise a (not shown) spring element, in particular a torsion spring, to assist in pivoting the door from the closed to the open position.

Furthermore, the hinge device 9 can comprise a (not shown) damper element, in particular a torsion damper, for damping the pivoting of the door from the closed to the open position. The spring element and/or damper element can be accommodated inside the first hinge parts 16 and/or the second hinge part 17.

As can be seen from FIG. 1 and FIG. 2, the overhead luggage compartment 3 is connected to the aircraft fuselage via connecting elements 25. The overhead luggage compartment 3 with the hinge device 9 described above is well suited for a particularly large-volume embodiment of the receiving space 7. In this embodiment, the overhead luggage compartment can comprise a rear connecting element 25A and a front connecting element 25B on each transverse side. Since the center of gravity of the overhead luggage compartment 3 including luggage is essentially in the middle of the four connecting elements 25, the force is evenly distributed, so that a particularly weight-saving design can be achieved. Preferably, at least one of the connecting elements 25, preferably the two front connecting elements 25B, is adjustable in length so that a tolerance compensation can be carried out.

### LIST OF REFERENCE NUMBERS

1 Aircraft cabin
2 Aircraft
3 Overhead luggage compartment
4 Luggage compartment housing
4A Side parts
4B Rear wall
5 Upper part
6 Lower part
7 Receiving space
8 Door
9 Hinge device
10 Pivot axis
11 Loading opening
12 Mounting clamp
13 Upper mounting leg
14 Lower mounting leg
15 Pivot arm
16 First hinge parts
17 Second hinge part
18 Screw connection
19 Recess
20 Ceiling panel
21 Lighting and ventilation device
22 Lighting elements
23 Longitudinal gap
24 Piece of luggage
25 Connecting elements
25A Rear connecting element
25B Front connecting element

1. An overhead luggage compartment for an aircraft, comprising:
a luggage compartment housing with two side parts, an upper part and a lower part, which enclose a receiving space for pieces of luggage,
a door, and
a hinge device connected to the upper part and the door, respectively, the door by means of the hinge device being pivotable relative to the luggage compartment housing between an open position and a closed position,
wherein
the hinge device comprises a mounting clamp having an upper mounting leg and a lower mounting leg, the upper mounting leg being attached to an upper side of the upper part and the lower mounting leg being attached to a lower side of the upper part.

2. The overhead luggage compartment according to claim 1, wherein a pivot axis of the hinge device extends in a plane between the upper and lower sides of the upper part of the luggage compartment housing.

3. The overhead luggage compartment according to claim 2, wherein the pivot axis of the hinge device extends in a plane essentially centrally between the upper and lower sides of the upper part of the luggage compartment housing.

4. The overhead luggage compartment according to claim 1, wherein the upper and lower mounting legs of the hinge device are pivotable relative to each other.

5. The overhead luggage compartment according to claim 1, wherein the upper and lower mounting legs of the hinge device are connected to each other by a screw connection.

6. The overhead luggage compartment according to claim 5, wherein the screw connection between the upper and lower mounting legs of the hinge device passes through a recess in the upper part of the luggage compartment housing.

7. The overhead luggage compartment according to claim 1, wherein the hinge device comprises a pivot arm which is attached to an inside of the door.

8. The overhead luggage compartment according to claim 7, wherein the hinge device comprises at least one first hinge part;
connected to the mounting clamp, and at least one second hinge part, connected to the pivot arm.

9. The overhead luggage compartment according to claim 1, wherein a lighting device is arranged on the upper side of the upper part of the luggage compartment housing.

10. The overhead luggage compartment according to claim 1, wherein in the open position of the door, a longitudinal gap is formed between the upper side of the upper part of the luggage compartment housing and an upper longitudinal side of the door relative to the closed position of the door.

11. The overhead luggage compartment according to claim 1, wherein the hinge device comprises a spring element for assisting in pivoting the door from the closed to the open position.

12. The overhead luggage compartment according to claim 1, wherein the hinge device comprises a damper element for damping the pivoting of the door from the closed to the open position.

13. An aircraft, comprising:
an aircraft fuselage with an aircraft cabin, and
the overhead luggage compartment according to claim 1, which is mounted in the aircraft cabin.

14. The overhead luggage compartment according to claim 8, wherein the at least one first hinge part is a first round part and the at least one second hinge part is a second round part.

15. The overhead luggage compartment according to claim 11, wherein the spring element is a torsion spring.

16. The overhead luggage compartment according to claim 12, wherein the damper element is a torsion damper.
